(19) United States
(12) Patent Application Publication
(10) Pub. No.: US 2025/0128792 A1
(43) Pub. Date: Apr. 24, 2025

(54) WATERBORNE AUTONOMOUS RESCUE DEVICE AND SYSTEM

(71) Applicant: FENG CHIA UNIVERSITY, Taichung City (TW)

(72) Inventors: Yu-Chen LIN, Taichung City (TW); Cheng-Yi LEE, Taichung City (TW); Liang Jiun HUANG, Taichung City (TW); Fu-Sheng CHANG, Taichung City (TW)

(73) Assignee: FENG CHIA UNIVERSITY, Taichung City (TW)

(21) Appl. No.: 18/427,561

(22) Filed: Jan. 30, 2024

(30) Foreign Application Priority Data
Oct. 23, 2023 (TW) 112140453

(51) Int. Cl. B63B 35/00

(52) U.S. Cl. CPC B63B 35/00; B63B 2035/007; B63B 2201/02

(57) ABSTRACT

A waterborne autonomous rescue device floats in a body of water and continuously senses an ambient audio in the body of water, and performs voice recognition on the ambient audio to recognize a cry-out-for-help voice, and calculates a direction of an emission source (e.g. a drowning person) that emits the cry-out-for-help voice, and then the waterborne autonomous rescue device will automatically move forward in the direction of the emission source, so that the drowning person can cling to the waterborne autonomous rescue device and be carried to a safe location; a waterborne autonomous rescue system includes the waterborne autonomous rescue device which is further connected to a monitoring device; a monitoring personnel can check the status of the waterborne autonomous rescue device through the monitoring device. When a drowning incident occurs, the monitoring personnel can go to a location of the waterborne autonomous rescue device to carry out subsequent rescue.

### CROSS REFERENCE TO RELATED APPLICATION(S)

This application claims the priority to patent application No. 112140453 filed in Taiwan on Oct. 23, 2023, which is hereby incorporated in its entirety by reference into the present application.

### BACKGROUND OF THE INVENTION

### 1. Field of the Invention

The present invention relates to a rescue device and system, in particular to an autonomous rescue device floating on water and a system including said device.

### 2. Description of the Related Art

Every summer, a large number of people go to beaches to play in water to relieve heat. However, there are repeated reports of drowning incidents caused by playing in the water. According to statistics released by the National Fire Agency of the Ministry of the Interior, the number of people rescued by firefighting agencies has been increasing year by year. From 2015 to 2020, the number of people rescued increased from 594 to 882. Among them, the majority of the people rescued were students, and according to statistics reported in the Ministry of Education's School Safety Bulletin, drowning accidents that occurred between 2015 and October 2021 claimed the lives of 668 students.

A main reason for the above-mentioned deplorable drowning accidents is usually that when a drowning accident occurs, the drowning victim is alone or unnoticed by others, thus a golden opportunity to rescue the victim is missed, or that the drowning victim is found immediately, but the finder is unable to rescue the drowning victim immediately, e.g. the finder does not have a rescue object (e.g. a lifebuoy) nearby for the drowning victim to grab, or the finder is not a professional lifeguard, and when the finder spends time looking for the rescue object or reporting to a lifeguard, a golden time for rescuing the drowning victim gradually passes away; hence how to increase the chances of rescuing a drowning person is a topic that needs great attention in today's society.

### SUMMARY OF THE INVENTION

When existing drowning accidents occur, a golden opportunity for rescue is usually missed due to various reasons as above mentioned, resulting in many drowning victims losing their lives without being successfully rescued. In view of this, the present invention proposes a waterborne autonomous rescue device and system to increase chances of successfully rescuing a drowning person.

A waterborne autonomous rescue device of the present invention includes:
a buoyant object;
an audio acquisition unit, disposed on the buoyant object, and the audio acquisition unit sensing an ambient audio in a body of water;
a driving module, disposed on the buoyant object; and
a central processing module disposed on the buoyant object and electrically connected to the audio acquisition unit and the driving module, the central processing module receiving the ambient audio and executing program data of a voice recognition model to recognize a cry-out-for-help voice from the ambient audio, and the central processing module calculating a direction of an emission source based on the cry-out-for-help voice to control the driving module to drive the buoyant object to move forward in the direction of the emission source.

A waterborne autonomous rescue system of the present invention includes:
at least one waterborne autonomous rescue device as hereinbefore described, and the at least one waterborne autonomous rescue device sending out an operation status information;
a server, communicating with the at least one waterborne autonomous rescue device, receiving and storing the operation status information of the at least one waterborne autonomous rescue device; and
a monitoring device communicating with the server to read and display the operation status information of the at least one waterborne autonomous rescue device.

The waterborne autonomous rescue device of the present invention floats in a body of water, continuously senses an ambient audio in the body of water, and performs voice recognition on the ambient audio to determine whether there is a cry-out-for-help voice in the ambient audio, when the ambient audio contains the cry-out-for-help voice, calculates the direction of an emission source (e.g. a drowning person) that emits the cry-out-for-help voice based on the cry-out-for-help voice. The waterborne autonomous rescue device will automatically move forward in the direction of the emission source. The drowning person can cling to the buoyant object and float on the water to wait for rescue, and that allows the drowning person to receive immediate relief within a golden time for rescue, thereby increasing the chance of successfully rescuing the drowning person subsequently.

The waterborne autonomous rescue system of the present invention connects the waterborne autonomous rescue device to a monitoring device through a server. A monitoring personnel can continuously check the operation status of the waterborne autonomous rescue device through the monitoring device to determine whether a drowning accident has occurred. When a drowning accident occurs, the waterborne autonomous rescue device immediately approaches the drowning person to seize the golden time for rescue, and the monitoring personnel can locate the waterborne autonomous rescue device through the monitoring device and go thereabouts to carry out subsequent rescue.

In order to make the above objects, features and advantages of the present invention more apparent and easier to understand, the following embodiments, together with the accompanying drawings, are described in detail as follows.

### BRIEF DESCRIPTION OF THE DRAWINGS

FIG. 1: Circuit block diagram of a waterborne autonomous rescue device of the present invention;

FIG. 2: Schematic diagram of an appearance of the waterborne autonomous rescue device of the present invention;

FIG. 3: Circuit block diagram of an embodiment of the waterborne autonomous rescue device of the present invention;

FIG. 4: Flow chart for calculating Mel-frequency cepstral coefficients by a feature acquisition unit in the waterborne autonomous rescue device of the present invention;

FIG. 5: Flowchart of an azimuth calculation unit in the waterborne autonomous rescue device of the present invention calculating the direction of an emission source;

FIG. 6: Circuit block diagram of the waterborne autonomous rescue system of the present invention;

FIG. 7: Circuit block diagram of the waterborne autonomous rescue system of the present invention, wherein a central processing module includes a wireless communication unit;

FIG. 8: A schematic diagram of a monitoring interface displayed by a monitoring device in the waterborne autonomous rescue system of the present invention;

FIG. 9: A schematic diagram of the monitoring interface displayed by the monitoring device in the waterborne autonomous rescue system of the present invention; and

FIG. 10: A schematic diagram of a formation sailing model executed by the waterborne autonomous rescue system of the present invention.

### DETAILED DESCRIPTION OF THE INVENTION

The technical contents, features and effects of the present invention will be clearly presented in the following detailed description of the preferred embodiment with reference to the drawings. In addition, the directional terms mentioned in the following embodiments, such as: up, down, left, right, front, back, bottom, top, etc., are only relative directions with reference to the drawings, and do not represent absolute directional positions; therefore, the directional terms used are for the convenience of illustrating their relative positional relationships, and are not intended to impose limitations on the present invention.

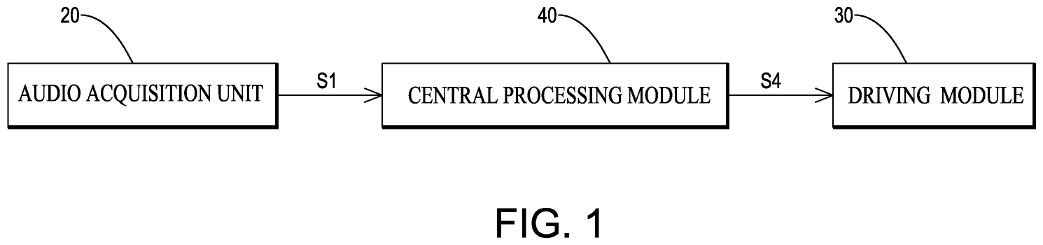

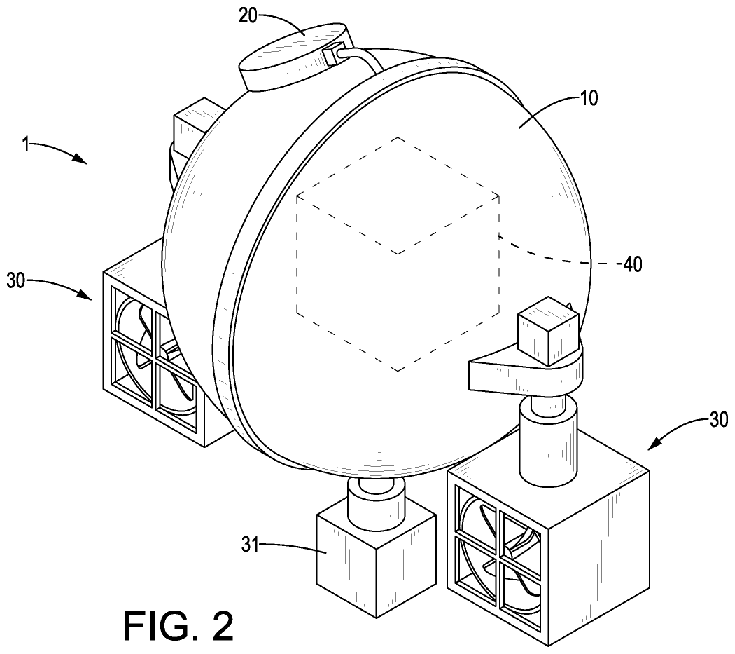

The present invention is a waterborne autonomous rescue device and system. Please refer to FIG. 1 and FIG. 2: firstly, the waterborne autonomous rescue device 1 contains a buoyant object 10, an audio acquisition unit 20, a driving module 30 and a central processing module 40, wherein the audio acquisition unit 20 and the driving module 30 are electrically connected to the central processing module 40 respectively.

The buoyant object 10 can float in a water area. The water area can be, for example, a lake, a bathing beach, etc. The buoyant object 10 can be a spherical buoy, a floating board, a lifebuoy or other objects that can float on water. Take the buoyant object 10 as a spherical buoy for example: when a drowning person is found in the water area, the buoyant object 10 can be moved to the vicinity of the drowning person for the drowning person to grab and float on the water surface without sinking. How the drowning person is found and how the buoyant object 10 is moved to the vicinity of the drowning person will be further described later.

The audio acquisition unit 20 is disposed on the buoyant object 10 to sense an ambient audio S1 of the water area and output the ambient audio S1 to the central processing module 40. Specifically, the audio acquisition unit 20 is an array microphone, and preferably, when the buoyant object 10 floats in the water area, the audio acquisition unit 20 is exposed on the water surface and able to receive the ambient audio from various angles. For example, the array microphone can include four audio receiver units. The array microphone collects sound through the four audio receiver units and can perform preliminary audio processing (such as noise suppression) on the ambient audio.

The driving module 30 is disposed on the buoyant object 10 and can be started or shut down according to the control of the central processing module 40. For example, as shown in FIG. 2, the driving module 30 includes two motors arranged at the bottom of the buoyant object 10. The transmission shafts of the two motors are respectively connected to a fan blade, and preferably, when the buoyant object 10 is floating in the water area, the two motors are located under the water surface. When each motor is started, it can drive the respectively connected fan blades, so as to drive the buoyant object 10 to move, wherein the rotational speeds of the two motors can be separately controlled, for example, when the rotational speeds of the two motors are the same, the buoyant object 10 will move forward in a straight line, and when the rotational speeds of the two motors are different, the buoyant object 10 will move forward to the left or to the right.

The central processing module 40 is disposed on the buoyant object 10. As mentioned above, taking the buoyant object 10 as a spherical buoy as an example, the central processing module 40 is disposed in an accommodation space inside the spherical buoy, and when the central processing module 40 receives the ambient audio S1 from the audio acquisition unit 20, the central processing module 40 executes program data of a voice recognition model to recognize a cry-out-for-help voice from the ambient audio S1, and the central processing module 40 calculates a direction of an emission source that emits the cry-out-for-help voice, and controls the driving module 30 to activate and drive the buoyant object 10 (the waterborne autonomous rescue device 1) to move in the direction of the emission source; wherein the central processing module 40 can be an embedded system, such as Jetson Nano module of NIVIDIA®.

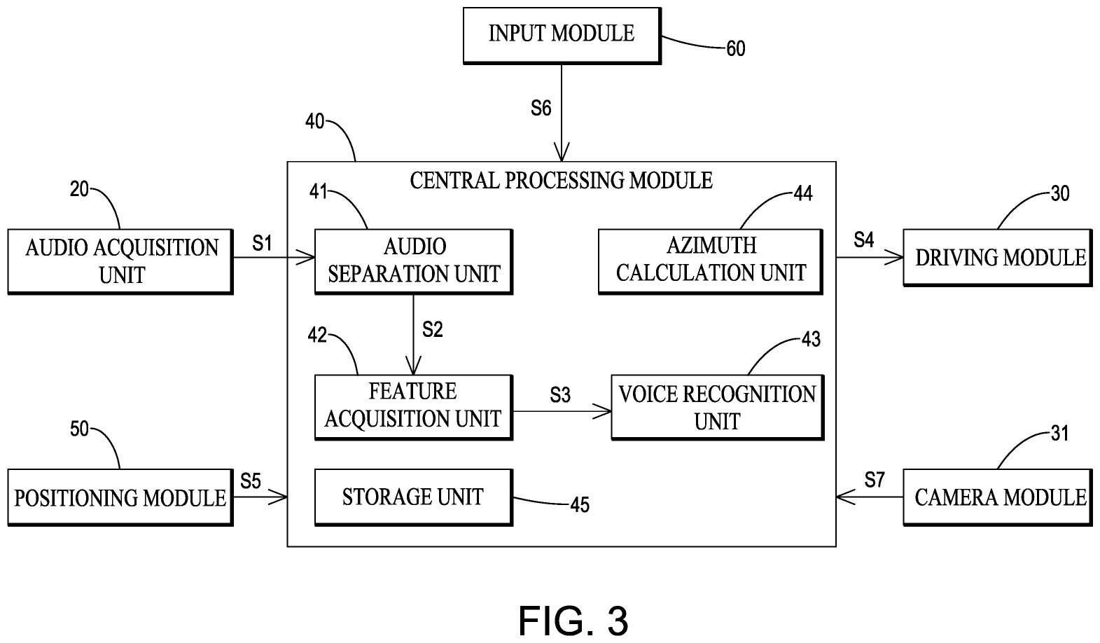

Regarding how the central processing module 40 performs voice recognition, please refer to FIG. 3. The central processing module 40 further includes an audio separation unit 41, a feature acquisition unit 42, a voice recognition unit 43, an azimuth calculation unit 44 and a storage unit 45, where the storage unit 45 can be a storage device such as a hard disk or a memory installed on the buoyant object 10, or it can be a network-attached storage (NAS) device not installed on the buoyant object 10. As mentioned above, if the central processing module 40 is a Jetson Nano module, the storage unit 45 is a memory in the Jetson Nano module.

The storage unit 45 stores operation data of the audio separation unit 41, the feature acquisition unit 42, the voice recognition unit 43 and the azimuth calculation unit 44. Each of the aforementioned units 41 to 44 has the capability to read and write the storage unit 45; for example, the storage unit 45 stores the program data of the voice recognition model, wherein the voice recognition model is trained in advance using a deep learning algorithm, such as a Convolutional neural network (CNN) algorithm, a Recurrent neural network (RNN) algorithm and other deep learning algorithms, and the present invention mainly uses the Convolutional neural network algorithm to train the voice recognition model, and stores the trained voice recognition model in the storage unit 45 for the voice recognition unit 43 to read and use. The training process of the voice recognition model is common knowledge in the pertained field and will not be described in detail here.

The audio separation unit 41 is electrically connected to the audio acquisition unit 20 to receive the ambient audio S1 transmitted by the audio acquisition unit 20 and reconstruct the ambient audio S1 to output a plurality of independent audios S2. Specifically, the ambient audio S1 is formed by the superposition of a plurality of original audios. The original audios may be partially broken and incomplete, and the audio separation unit 41 may extrapolate complete contents of the original audios and carry out the reconstruction according to different situations, and then reconstruct the original audios through Independent components analysis (ICA) and Blind source separation (BSS) techniques to separate the original audios into a plurality of independent original audios to output the plurality of independent audios S2.

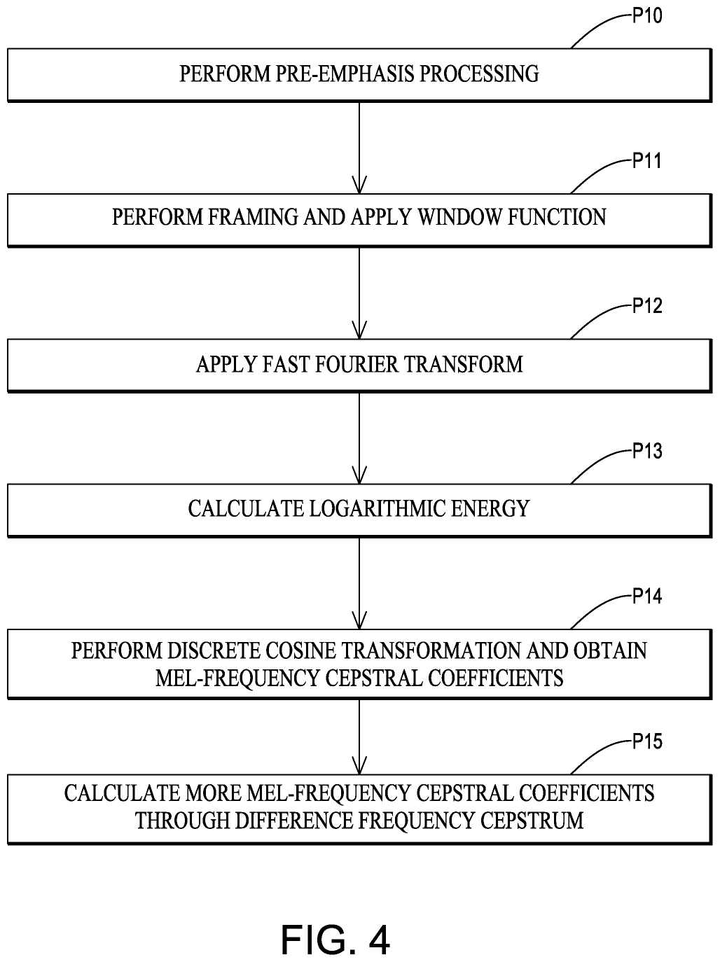

The feature acquisition unit 42 is electrically connected to the audio separation unit 41 to receive the plurality of independent audios S2, and performs feature extraction on each independent audio S2 to output a plurality of feature information S3 respectively of each independent audio S2. For example, through a Mel-frequency cepstral coefficients (MFCC) algorithm the feature acquisition unit 42 can divide each independent audio S2 into multiple analysis segments, and through the algorithm to obtain a Mel-frequency cepstrum of each independent audio S2 wherein each Mel-frequency cepstrum contains the plurality of feature information S3 of the independent audio S2. Regarding the calculation method of the Mel-frequency cepstral coefficients algorithm, as shown in FIG. 4, it includes the following steps:

Step P10: Perform pre-emphasis processing on each independent audio S2, that is, calculate each independent audio S2 through a high-pass filter formula to remove low-frequency signals in each independent signal S2, so as to enhance the signal recognition of other frequency bands in the independent signal S2, and the high-pass filter formula is as follows:

$$Y ( n ) = x ( n ) - ax ( n - 1 )$$

Where Y(n) denotes an output signal, x(n) is an independent signal S2, and a is a constant between 0.9 and 1.0.

Step P11: The pre-emphasis processing result is divided into frames and then applied window function (Cosine window). Because the pre-emphasis processing result is still a continuous signal, in order to avoid the signal length being too long and difficult to analyze, framing is performed. For example, the time length of each frame of audio can be 20 to 30 microseconds. In order to reduce signal leakage due to framing, a window function is applied, such as applying a Hamming window function, and the formula is as follows:

$$W ( n ) = Y ( n ) [ 0.53 - 0.46 cos \frac{2 π n}{N - 1} ]$$

Where n=0, 1, 2, 3 . . . N−1, W(n) denotes each frame of audio processed by applying the window function, Y(n) denotes the output signal after the above pre-processing, and N denotes the number of sampling frames.

Step P12: Apply fast Fourier transform on each windowed frame of audio to convert each frame of audio into a frequency domain signal. The formula is as follows:

$$X ( k ) = {\sum }_{n = 0}^{N - 1} W ( n ) {e}^{- 2 π nk / N}$$

Where, X(k) denotes one of the frequency domain signals, W(n) denotes each frame of audio processed by applying the abovementioned window function, N denotes the number of sampled frames, and k is a whole number between 0 and N.

Step P13: Calculate a logarithmic energy using a Mel filter bank and a logarithmic operation, where the Mel filter bank contains a plurality of Mel filters, and each of the Mel filters is a triangular bandpass filter, and the plurality of triangular bandpass filters are distributed evenly over Mel-frequency, and the logarithmic energy is calculated as follows:

$$L ( m ) = log [ {\sum }_{{f}_{m - 1}}^{{f}_{m + 1}} {\vert X ( k ) \vert}^{2} \cdot Hm ( k ) ]$$

Where L(m) is the logarithmic energy, X(k) is a frequency domain signal, Hm(k) is a frequency response of the Mel filter bank, m is the number of Mel filters, and f is the frequency.

Step P14: Perform discrete cosine transformation on each logarithmic energy to obtain Mel-frequency cepstral coefficients. The calculation formula is as follows:

$${C}_{m} = {\sum }_{m = 1}^{N} L ( m ) cos [ n ( m - 0.5 ) π / N ]$$

Where n=0, 1, 2, 3 . . . L, Cm denotes the Mel-frequency cepstral coefficients, L(m) is the logarithmic energy, N is the number of delta filters, and L is the order number, which is usually an integer between 12 and 16, e.g., L=13 means that the first 13 Mel-frequency cepstral coefficients are extracted, and each Mel-frequency cepstral coefficient is a feature information S3.

In addition, more of the feature information can be calculated through a difference frequency cepstrum calculation formula in step P15, where the calculation formula is as follows:

$$Δ {C}_{m} ( t ) = [ {\sum }_{τ = - M}^{M} {C}_{m} ( t + τ ) \cdot τ ] / [ {\sum }_{τ = - M}^{M} {τ}^{2} ]$$

Where, ΔCₘ(t) is the change in time of each of the Mel-frequency cepstral coefficients, τ is the amount of time variation, M is a constant usually between 2 and 3, when M is equal to 2, 26 Mel-frequency cepstral coefficients will be generated, and when M is equal to 3, 39 Mel-frequency cepstral coefficients will be generated.

It should be noted that the voice recognition unit 43 can only receive two-dimensional information (images), and the ambient audio S1 is one-dimensional information, so the Mel-frequency cepstral coefficients (MFCC) algorithm described above calculates a plurality of feature information S3 which are input to the voice recognition unit 43.

When the voice recognition unit 43 receives the plurality of feature information S3, the voice recognition unit 43 executes the program data of the voice recognition model pre-trained in the storage unit 45, and classifies the plurality of feature information S3 to confirm whether the plurality of feature information S3 contains the feature information of a cry-out-for-help voice. If the plurality of feature information S3 contains the feature information of the cry-out-for-help voice, it means that the ambient audio S1 contains the cry-out-for-help voice; if the plurality of feature information S3 does not contain the feature information of the cry-out-for-help voice, it means that the ambient audio S1 does not contain the cry-out-for-help voice.

As mentioned above, for example, the voice recognition model is trained through a Convolutional Neural Network (CNN) algorithm. The process of classifying the plurality of feature information S3 by the voice recognition model is as follows: by giving a kernel (filter) on each feature information S3 (image), the kernel continuously moves and scans in each feature information S3 to obtain a feature map, and the calculation method is as follows:

$$y = S ( {\sum }_{i = 1 , j = 1}^{k} {W}_{ij} {C}_{m} + b )$$

Where, y is the feature map (expressed in the form of matrix values), Wᵢⱼ is the kernel, usually a k by k matrix, Cm is the feature information (the above-mentioned Mel-frequency cepstral coefficients), and b is a deviation value, S is an activation function, for example, the Sigmoid function, Rectified linear unit (ReLU), etc.; first, highlight each feature information through the activation function, and then use at least one pooling layer to compress the feature information to retain important information. At least one fully-connected layer converts the content output by the at least one pooling layer into a plurality of one-dimensional feature vectors, performs 1×1 convolution, and classifies the computation results to obtain the feature map.

The audio acquisition unit 20 continuously transmits the ambient audio S1 of the water area to the central processing module 40, so that the audio separation unit 41, the feature acquisition unit 42, and the voice recognition unit 43 perform computations on the ambient audio S1 to continuously determine whether a cry-out-for-help voice is contained in the ambient audio S1, and when the ambient audio S1 contains the cry-out-for-help voice, the azimuth unit 44 calculates the direction of an emission source of the cry-out-for-help voice by a Time difference of arrival (TDOA) method.

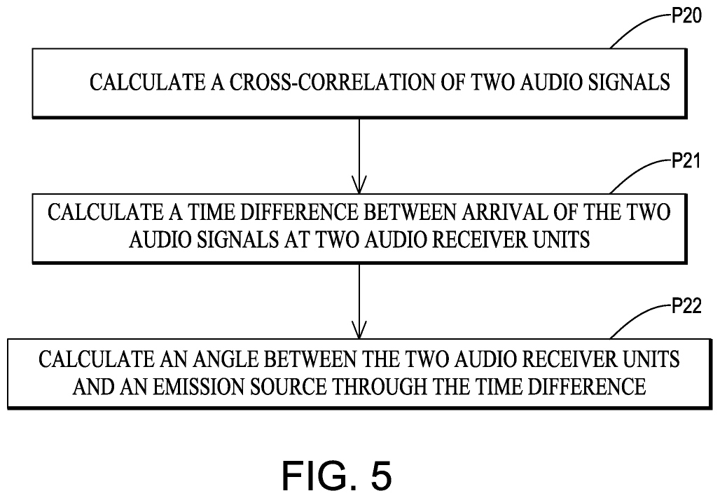

Specifically, the audio acquisition unit 20 includes four audio receiver units as mentioned above, and the azimuth calculation unit 44 calculates the time difference of the cry-out-for-help voice sent to any two of the four audio receiver units through the Time difference of arrival (TDOA) method, and then calculates an angle between the two audio receiver units and the emission source through the time difference. Among them, because the audio acquisition unit 20 has a total of four audio receiver units, then there can be a total of six combinations (C₂=6) if two of the four audio receiver units are selected arbitrarily, and six included angles can be obtained thereby. Please refer to FIG. 5. The Time difference of arrival method can include the following calculation steps:

Step P20: Calculate the cross-correlation (CC) of the two audio signals input to the two audio receiver units. Specifically, the two audio receiver units are a first audio receiver unit and a second audio receiver unit, the emission source emits the cry-out-for-help voice, the first audio receiver unit receives a first audio, the second audio receiver unit receives a second audio, and the formula used to calculate the cross-correlation between the first audio and the second audio is as follows:

$${R}_{i} ( λ ) = {\sum }_{n = 1}^{N} {m}_{1 i} ( n ) {m}_{2 i} ( n + λ )$$

Where Ri(λ) is the correlation of the two signals, N is the number of audio frame samples, m1 and m2 are the two signals, i is the audio frame number, and λ is the number of displacement sampling points (a difference of the number of sampling points between the starting points of the two adjacent audio frames); find the maximum of Ri(λ) by constantly changing the value of λ, which means finding the maximum correlation between the two signals.

Step P21: Calculate the time difference between the arrival of the two audio signals at the two audio receiver units (TDOA), and the calculation method is as follows:

$$TDOA = λ / f$$

Where TDOA is the time difference, λ is the λ when the correlation of the two tones is at its maximum value, and f is a sampling frequency.

Step P22: Calculate the angle between the two audio receiver units and the emission source by the time difference value, which is calculated as follows:

$$θ = {cos}^{- 1} ( \frac{v \cdot TDOA}{\vert {m}_{x 1} - {m}_{x 2} \vert} )$$

Where mₓ₁ and mₓ₂ are the positions of the two audio receiver units, v is the speed of sound, and TDOA is the time difference; when the six distinct included angles are calculated by the above Time difference of arrival method, an average value of the six included angles is taken as the direction of the emission source of the cry-out-for-help voice.

Please refer to FIG. 3 again. After the central processing module 40 calculates the emission source direction, the central processing module 40 outputs a control signal S4 to the driving module 30, and based on the control signal S4 received, the driving module 30 activates and drives the buoyant object 10 (the waterborne autonomous rescue device 1) to move towards the emission source. In one embodiment of the present invention, the central processing module 40 is also electrically connected to a positioning module 50.

The positioning module 50 can be, for example, a positioning module that supports Global Positioning System (GPS). The positioning module 50 is disposed on the buoyant object 10 and transmits a positioning signal S5 to the central processing module 40 based on the position of the buoyant object 10. In addition, the positioning module 50 includes an electronic compass; as a result, the positioning signal S5 has a coordinate information and an azimuth information.

The coordinate information is used to represent a current position of the buoyant object 10, and the azimuth information indicates the direction in which the buoyant object 10 is facing. When the central processing module 40 calculates the emission source direction, the central processing module 40 combines the emission source direction and the azimuth information to control the driving module 30 to drive the buoyant object 10 to move forward in a straight line, or to turn left or right to follow the emission source direction.

In addition, the storage unit 45 stores coordinate information of a safe location which is located around the water area, and as shown in FIG. 3, in one embodiment of the present invention, the central processing module 40 is further connected to an input module 60, and the input module 60 is installed on the buoyant object 10, and can generate an input signal S6 to the central processing module 40 according to operation of a user (drowning person). When the central processing module 40 receives the input signal S6, the central processing module 40 controls the driving Module 30 to move the buoyant object 10 towards the safe location, where the location of the user (drowning person) is the location of the emission source; for example, the input module 60 is a button on the exterior of the buoyant object 10. After the user (drowning person) clings to the buoyant object 10 and presses the button, the waterborne autonomous rescue device 1 will take the user (drowning person) to the safe location; or, the input module 60 is a weight sensor, when the user (drowning person) clings to the buoyant object 10, the weight sensed by the weight sensor will generate a change to send the input signal S6 to the central processing module 40, so that the central processing module 40 controls the waterborne autonomous rescue device 1 to carry the user (drowning person) to the safe location.

Please refer to FIG. 2 and FIG. 3 again. In an embodiment of the present invention, the central processing module 40 is further electrically connected to a camera module 31, which is located on the buoyant object 10, and which is used to capture underwater images of the water area to output real time images S7 to the central processing module 40. The central processing module 40 identifies, in the real time images S7, a target that sends out an ask-for-help signal, and controls the driving module 30 to drive the buoyant object 10 towards the target. Specifically, when the target (drowning person) sinks under the water and the audio acquisition unit 20 cannot receive the cry-out-for-help voice, the waterborne autonomous rescue device 1 can still use the camera module 31 to capture underwater images of the water area, use the central processing module 40 to identify the target in the real time images S7 through image recognition technology, and control the driving module 30 to drive the buoyant object 10 to move to the target, thus achieving more accurate search and rescue functions. How the central processing module 40 recognizes the target from the real time image S7 and calculates the distance to the target through image recognition technology is common knowledge in the field of image processing technology and will not be described in detail herein.

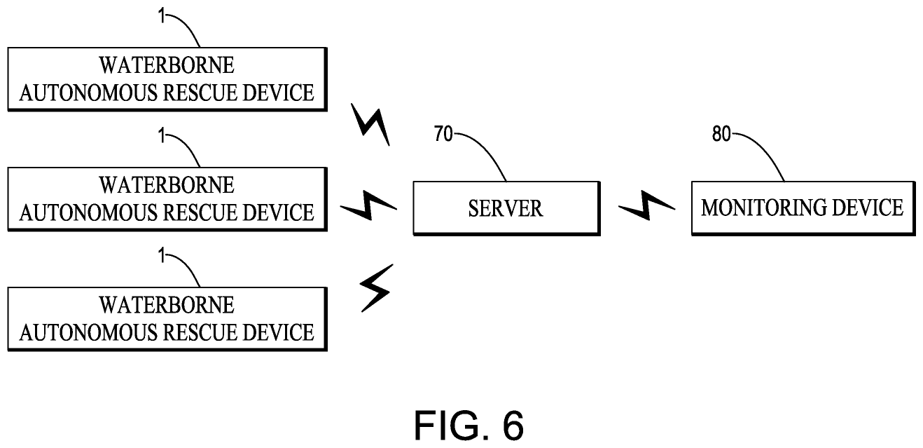

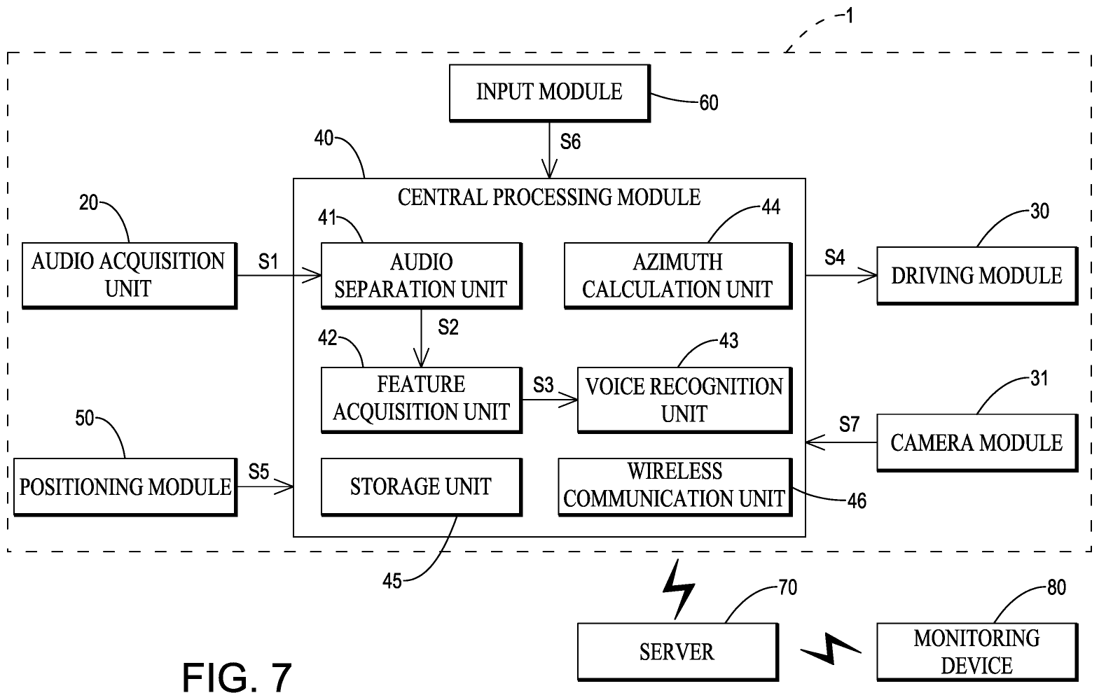

Please refer to FIG. 6. The waterborne autonomous rescue system of the present invention includes at least one waterborne autonomous rescue device 1, a server 70 and a monitoring device 80. The server 70 is communicatively connected to the waterborne autonomous rescue device 1 and the monitoring device 80. Specifically, please refer to FIG. 7, where only a waterborne autonomous rescue device 1 is shown for the purpose of facilitating the description of the waterborne autonomous rescue device 1, the server 70, and the monitoring device 80; in said system, the central processing module 40 also includes a wireless communication unit 46, through which the central processing module 40 can communicate with the server 70; for example, the wireless communication unit 46 is a communication unit supporting an Ethernet communication protocol. The server 70 serves as a data access and management core, integrating and managing different databases, and the server 70 has data access and other functions. The central processing module 40 transmits an operation status information of the waterborne autonomous rescue device 1 through the wireless communication unit 46 to the server 70. The operation status information includes, for example, the emission source direction, the azimuth information of the waterborne autonomous rescue device 1 itself, and other information. The server 70 stores each information in the operation status information in different databases.

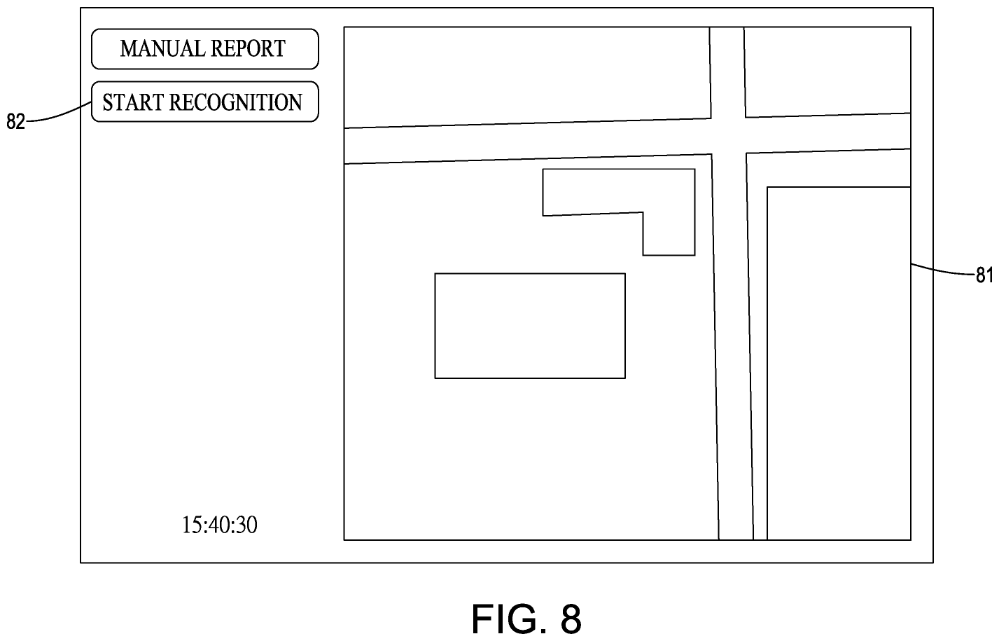

The monitoring device 80 can communicate with the server 70 to read an operation status of the waterborne autonomous rescue device 1, and the monitoring device 80 can also control the waterborne autonomous rescue device 1 through the server 70, for example, control the waterborne autonomous rescue device 1 to begin to sense the ambient audio S1. For example, the monitoring device 80 can be an electronic device such as a mobile phone, a tablet, or a computer. For example, the monitoring device 80 is a computer which includes a monitor. When the monitoring device 80 is connected to the server 70 and executes a monitoring function, the monitor will display a monitoring interface as shown in FIG. 8, and the monitoring interface displays an electronic map 81 and a start recognition button 82.

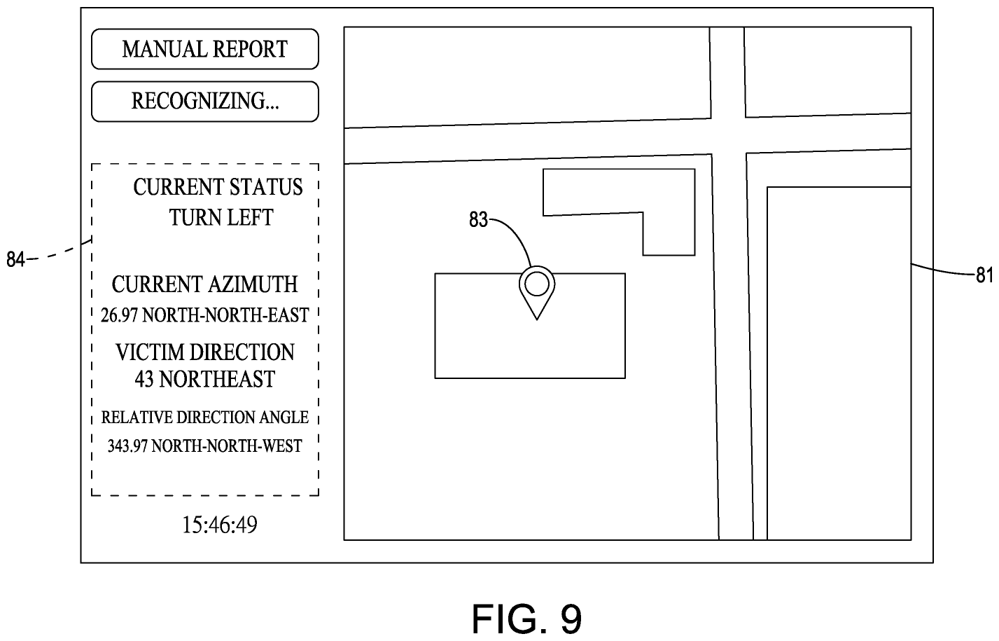

When a monitoring personnel clicks the start recognition button 82, the audio acquisition unit 20 will begin to sense the ambient audio S1 and transmit it to the central processing unit 40 for information calculation and judgment, and the central processing unit 40 will receive the positioning signal S5 sent by the positioning module 50 as shown in FIG. 9. During the above process, an operation status of the central processing unit 40 will be sent to the server 70 through the wireless communication unit 46, and the monitoring interface will display the information received by the server 70 in real time. For example, the monitoring interface will display an icon 83 in the electronic map 81 to indicate a current location of the waterborne autonomous rescue device 1, and a status list 84 will be displayed on one side of the electronic map 81, and the status list 84 will display the operation status of the autonomous rescue device 1, for example, the current azimuth angle (i.e. the azimuth information of the waterborne autonomous rescue device 1), the orientation of the drowning person (i.e. the direction of the emission source), the movement status of the buoyant object 10, etc.

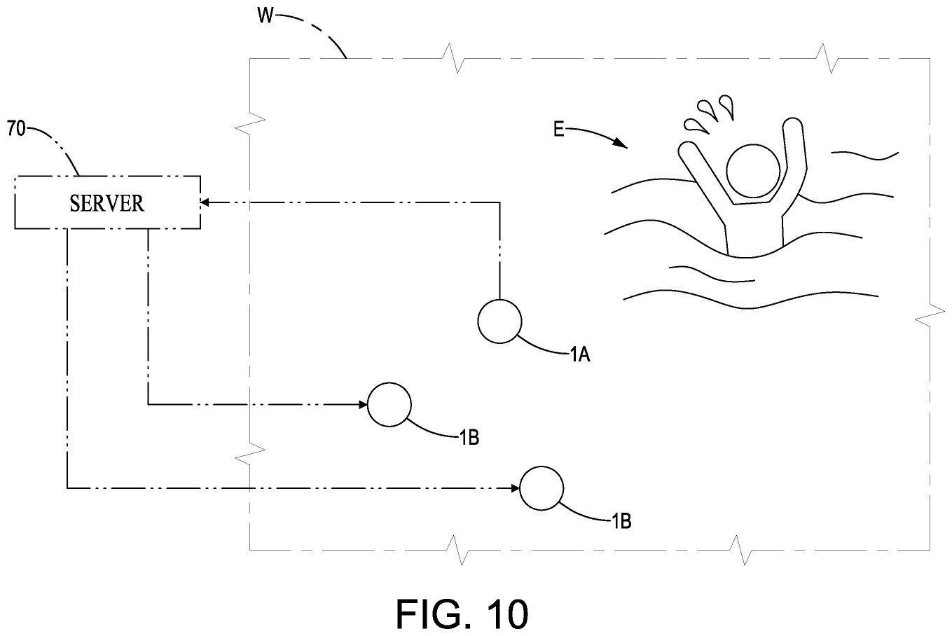

In addition, the waterborne autonomous rescue system of the present invention can also execute a formation sailing model. For example, please refer to FIG. 10: the at least one waterborne autonomous rescue device 1 includes a pilot rescue device 1A and at least one follower rescue device 1B. The pilot rescue device 1A and the at least one follower rescue device 1B have the same hardware structure and float together in rescue water W. When the pilot rescue device 1A calculates the direction of an emission source E (a drowning person) based on the received ambient audio, the pilot rescue device 1A transmits direction information of the emission source E to the server 70, and the server 70 sends the direction information of the emission source E to the at least one follower rescue device 1B, so that the pilot rescue device 1A and the at least one follower rescue device 1B move towards the emission source in a formation mode, where, the formation mode of the pilot rescue device 1A and the at least one follower rescue device 1B is a drone formation flying mode, such as a wedge formation, a trapezoidal formation, etc., and without being limited by such. How the drone formation flying in formation is common knowledge in the technical field described herein, and will not be repeated herein.

The waterborne autonomous rescue device of the present invention floats in a water area, continuously senses an ambient audio in the water area, and performs voice recognition on the ambient audio to determine whether there is a cry-out-for-help voice in the ambient audio. When the ambient audio contains the cry-out-for-help voice, the direction of an emission source (a drowning person) that emits the cry-out-for-help voice is calculated through the Time difference of arrival method. The waterborne autonomous rescue device will automatically move towards the direction of the emission source. The drowning person can cling to the buoyant object and float on the water to wait for rescue. This means that when a drowning accident occurs, the waterborne autonomous rescue device can immediately go to a drowning person, such that the drowning person will be rescued within a golden time for rescue, thereby increasing the probability of the drowning person being successfully rescued subsequently. The waterborne autonomous rescue system of the present invention connects the waterborne autonomous rescue device to a monitoring device through a server. The monitoring personnel can continuously check the operation status of the waterborne autonomous rescue device through the monitoring device to determine whether a drowning accident has occurred. When a drowning accident occurs, the waterborne autonomous rescue device immediately goes to the drowning person to seize the golden time for rescue, and the monitoring personnel can locate the waterborne autonomous rescue device through the monitoring device and go thereabouts to carry out subsequent rescue.

In summary, the above is only a description of the implementation modes or examples of the technical means used in the present invention to present a solution to a problem, and is not intended to limit the claims of the present invention. That is to say, all the changes and modifications that are consistent with the meaning of the claims of the present invention or in accordance with the claims of the present invention are covered by the claims of the present invention.

Although the present invention has been disclosed as above by way of a preferred embodiment, it is not intended to limit the present invention, and any one skilled in the art may make certain changes and modifications without departing from the spirit and scope of the present invention, and therefore the scope of protection of the present invention shall be subject to the scope of the appended patent claims as defined herein.

What is claimed is:

1. A waterborne autonomous rescue device, including:
a buoyant object;
an audio acquisition unit, disposed on the buoyant object and configured to sense an ambient audio in a body of water;
a driving module, disposed on the buoyant object; and
a central processing module, disposed on the buoyant object and electrically connected to the audio acquisition unit and the driving module, and the central processing module receiving the ambient audio and executing program data of a voice recognition model to recognize a cry-out-for-help voice in the ambient audio, and the central processing module calculating a direction of an emission source based on the cry-out-for-help voice to control the driving module to drive the buoyant object to move in the direction of the emission source.

2. The waterborne autonomous rescue device as claimed in claim 1, wherein the central processing module includes an audio separation unit and a feature acquisition unit; the audio separation unit receives the ambient audio and uses the independent components analysis (ICA) principle and blind source separation (BSS) technology to separate a plurality of independent audios from the ambient audio; the feature acquisition unit receives the plurality of independent audios and uses the Mel-frequency cepstral coefficients (MFCC) algorithm to perform feature extraction on the plurality of independent audios to output a plurality of feature information.

3. The waterborne autonomous rescue device as claimed in claim 2, wherein the central processing module includes a voice recognition unit, the voice recognition unit receives the plurality of feature information, and executes the program data of the voice recognition model to classify the plurality of feature information to confirm whether the plurality of feature information contains the feature information of the cry-out-for-help voice.

4. The waterborne autonomous rescue device as claimed in claim 1, wherein the central processing module calculates the direction of the emission source that emits the cry-out-for-help voice through a Time difference of arrival (TDOA) method; the voice recognition model is trained through a Convolutional neural network (CNN) algorithm.

5. The waterborne autonomous rescue device as claimed in claim 1, wherein the audio acquisition unit includes four audio receiver units, and the central processing module calculates a time difference of the cry-out-for-help voice sent to any two of the four audio receiver units through the Time difference of arrival (TDOA) method, and then calculates an angle between the two audio receiver units and the emission source through the time difference, where the direction of the emission source is an average value of six non-overlapping included angles obtained by the central processing module after six calculations.

6. The waterborne autonomous rescue device as claimed in claim 1, wherein the central processing module is further electrically connected to a positioning module which is disposed on the buoyant object and transmits a positioning signal to the central processing module according to the position of the buoyant object, and the positioning module includes an electronic compass, such that the positioning signal includes a coordinate information and an azimuth information.

7. The waterborne autonomous rescue device as claimed in claim 6, wherein the driving module includes two motors arranged at a bottom of the buoyant object, and rotation speeds of the two motors can be separately controlled; when the central processing module calculates the direction of the emission source, the central processing module combines the emission source direction and the azimuth information to control the driving module to drive the buoyant object to move forward in the emission source direction.

8. The waterborne autonomous rescue device as claimed in claim 1, wherein the central processing module stores coordinate information of a safe location, and the central processing module is electrically connected to an input module which is disposed on the buoyant object and able to generate an input signal to the central processing module according to operation of a user, and when the central processing module receives the input signal, the central processing module controls the driving module to drive the buoyant object to move forward in the direction of the safe location, where the location of the user is the location of the emission source.

9. The waterborne autonomous rescue device as claimed in claim 1, wherein the central processing module is further electrically connected to a camera module which is disposed on the buoyant object and used to capture underwater images of the body of water to output real time images to be output to the central processing module, and the central processing module identifies a target in the real time images that sends out an ask-for-help signal, and controls the driving module to drive the buoyant object to move forward to the target.

10. A waterborne autonomous rescue system, including:
at least one waterborne autonomous rescue device sending out an operation status information;
a server, communicating with the at least one waterborne autonomous rescue device, and receiving and storing the operation status information of the at least one waterborne autonomous rescue device; and
a monitoring device communicating with the server to read and display the operation status information of the at least one waterborne autonomous rescue device; wherein
each of the at least one waterborne autonomous rescue device includes:
a buoyant object;
an audio acquisition unit, disposed on the buoyant object and configured to sense an ambient audio in a body of water;
a driving module, disposed on the buoyant object; and
a central processing module, disposed on the buoyant object and electrically connected to the audio acquisition unit and the driving module, and the central processing module receives the ambient audio and executes program data of a voice recognition model to recognize a cry-out-for-help voice in the ambient audio, and the central processing module calculates a direction of an emission source based on the cry-out-for-help voice to control the driving module to drive the buoyant object to move in the direction of the emission source.

11. The waterborne autonomous rescue system as claimed in claim 10, wherein the central processing module includes an audio separation unit and a feature acquisition unit; the audio separation unit receives the ambient audio and uses the independent components analysis (ICA) principle and blind source separation (BSS) technology to separate a plurality of independent audios from the ambient audio; the feature acquisition unit receives the plurality of independent audios and uses the Mel-frequency cepstral coefficients (MFCC) algorithm to perform feature extraction on the plurality of independent audios to output a plurality of feature information.

12. The waterborne autonomous rescue system as claimed in claim 11, wherein the central processing module includes a voice recognition unit, the voice recognition unit receives the plurality of feature information, and executes the program data of the voice recognition model to classify the plurality of feature information to confirm whether the plurality of feature information contains the feature information of the cry-out-for-help voice.

13. The waterborne autonomous rescue system as claimed in claim 10, wherein the central processing module calculates the direction of the emission source that emits the cry-out-for-help voice through a Time difference of arrival (TDOA) method; the voice recognition model is trained through a Convolutional neural network (CNN) algorithm.

14. The waterborne autonomous rescue system as claimed in claim 10, wherein the audio acquisition unit includes four audio receiver units, and the central processing module calculates a time difference of the cry-out-for-help voice sent to any two of the four audio receiver units through the Time difference of arrival (TDOA) method, and then calculates an angle between the two audio receiver units and the emission source through the time difference, where the direction of the emission source is an average value of six non-overlapping included angles obtained by the central processing module after six calculations.

15. The waterborne autonomous rescue system as claimed in claim 10, wherein the central processing module is further electrically connected to a positioning module which is disposed on the buoyant object and transmits a positioning signal to the central processing module according to the position of the buoyant object, and the positioning module includes an electronic compass, such that the positioning signal includes a coordinate information and an azimuth information.

16. The waterborne autonomous rescue system as claimed in claim 15, wherein the driving module includes two motors arranged at a bottom of the buoyant object, and rotation speeds of the two motors can be separately controlled; when the central processing module calculates the direction of the emission source, the central processing module combines the emission source direction and the azimuth information to control the driving module to drive the buoyant object to move forward in the emission source direction.

17. The waterborne autonomous rescue system as claimed in claim 10, wherein the central processing module stores coordinate information of a safe location, and the central processing module is electrically connected to an input module which is disposed on the buoyant object and able to generate an input signal to the central processing module according to operation of a user, and when the central processing module receives the input signal, the central processing module controls the driving module to drive the buoyant object to move forward in the direction of the safe location, where the location of the user is the location of the emission source.

18. The waterborne autonomous rescue system as claimed in claim 10, wherein the central processing module is further electrically connected to a camera module which is disposed on the buoyant object and used to capture underwater images of the body of water to output real time images to be output to the central processing module, and the central processing module identifies a target in the real time images that sends out an ask-for-help signal, and controls the driving module to drive the buoyant object to move forward to the target.
